(19) United States
(12) Patent Application Publication
(10) Pub. No.: US 2025/0062431 A1
(43) Pub. Date: Feb. 20, 2025

(54) PROCESS

(71) Applicant: Mexichem Fluor S.A. de C.V., San Luis Potosi (MX)

(72) Inventors: Andrew Sharratt, Runcorn (GB); Jamie Brooks, Runcorn (GB)

(21) Appl. No.: 18/580,335

(22) PCT Filed: Jul. 20, 2022
(86) PCT No.: PCT/GB2022/051874

§ 371 Date: Jan. 18, 2024

(30) Foreign Application Priority Data
Jul. 22, 2021 (GB) 2110568.9

(51) Int. Cl. H01M 10/54; C01D 15/00

(52) U.S. Cl. CPC H01M 10/54; C01D 15/005; C01P 2002/86; C01P 2002/87; C01P 2006/40

(57) ABSTRACT

A method of recovering a lithium salt from a lithium battery waste mass, comprising the steps of: (a) dissolving the lithium sail in the lithium battery waste mass in a weight of water equivalent to 100 to 0.1 times the weight of the lithium battery waste mass, either in a one-off treatment or successive treatments; (b) evaporating the aqueous solution to dryness; and (c) working up the dry residue with a solvent comprising water, a carbonate, or mixtures thereof.

The present invention relates to a process for recovering metal salts, in particular lithium salts, contained in an electrolyte.

The need for effective and sustainable recycling of components from lithium ion batteries has never been more important, particularly with the anticipated surge in demand for lithium ion batteries in technology such as electric vehicles to name one of many possible end uses, and the scarcity of some key elements in this technology. Use of electrochemical storage systems like lithium ion batteries are critical to ensure renewable energy sources can reduce societal reliance on fossil fuels.

Processes for recycling electrolyte salts exist in the prior art, however the vast majority of recycling methods in the context of lithium batteries focus on the recovery and recycling of the other battery components, such as the cathode, anode, casings and current collectors. Specifically, because of its cost, lithium is a focus of recovery processes. However, a number of components retain their value at the end of the battery life, such as nickel, copper and cobalt, Others, such as steel and aluminium, make use of existing, relatively straightforward recycling processes. Further, as they tend to represent a large proportion of the battery's composition, extraction and purification is economically relatively viable.

There is also the concern the demand for lithium might outpace the amount able to be sourced from lithium reserves in the foreseeable future, despite these being presumed to be sufficiently stocked, urgently forcing a need for innovative capture technology to be made commercially available.

Little consideration appears to have been given to the electrolytes and components within batteries (salts, additives and the lithium), and most waste battery treatments focus on removing or destroying these materials at the start of processing. Largely this is because they are deemed hazardous to work with during lengthy recycling processes, and are additionally of a relatively low concentration within batteries. Additionally, it is thought that the composition of some components such as that of lithium hexafluorophosphate (LiPF₆) changes during battery ageing, due to their inherent chemical and thermal instabilities, making attempts at their extraction frivolous. Electrolytic degradation is further influenced by the quality of species within the cell, e.g., the presence of impurities of protic species have a detrimental effect on capacity and cell lifetime.

However, the electrolyte and its constituents make up to roughly 10% by weight of lithium ion batteries, so development of technologies and techniques to make recycling feasible are required. This is particularly true when considering that the anticipated rise in demand for lithium ion batteries will generate an equivalent rise in waste, so recycling methods must emerge as required. Studies aimed at extracting electrolytes have typically used supercritical CO₂ without solvent addition, though only from individual discharged battery cells, as opposed to a collective assortment of waste material.

WO2015/193261 (Rhodia Operations) describes a process for recovering a metal salt of an electrolyte dissolved in a matrix, consisting in subjecting the electrolyte to a liquid extraction with water. Preferred salts are specific lithium salts known to be stable in water e.g., sulfonimides, perchlorates and sulphonates. In more detail, the processes described therein teach the isolation of lithium salts from a non-conductive matrix by the simple addition of water. Where the non-conductive matrix for the electrolyte salt comprises an organic solvent, this document teaches the use of a water-immiscible organic extraction solvent. This is so that organic solvent in the non-conductive matrix may be removed and retained in the organic phase, the resulting aqueous and organic phases being immiscible, e.g., forming two distinct phases after settling out or centrifugation, at 25° C. and at atmospheric pressure.

US 2017/0207503 (Commissariat a l'Energie Atomique et aux Energies Alternatives) relates to a method for recycling an electrolyte containing a lithium salt of formula LiA, where A represents an anion selected from PF₆⁻, CF₃SO₃⁻, BF₄⁻, ClO₄⁻ and [(CF₃SO₂)₂]N⁻ of a lithium ion battery, comprising the following steps of: a) optionally, processing the battery to recover the electrolyte that it contains; b) adding water to the electrolyte; c) optionally, when step a) is employed, filtering (F1) to separate the liquid phase containing the electrolyte from the solid phase comprising the residues of the battery; d) adding an organic solvent of addition to the liquid phase obtained in step b) or, when step a) is employed, after filtering (F1) in step c): e) decanting the liquid phase obtained after step b) of adding water or step d) of adding organic solvent of addition, whereby an aqueous phase containing the lithium salt and an organic phase containing the electrolyte solvents and the organic solvent of addition are obtained; f) distilling the organic phase obtained in step e) to separate the solvents of the electrolyte and the organic solvent of addition; g) precipitating the anion A of the lithium salt by addition of pyridine and then filtering (F2); h) adding at least one carbonate salt and/or of at least one phosphate salt to the filtrate obtained in step g) and then filtering (F3), whereby a lithium salt and water are obtained.

U.S. Pat. No. 7,820,317 (Tedjar) describes a method for treating lithium anode cells including dry crushing the cell at room temperature in an inert atmosphere, treatment by magnetic separation and densimetric table, and aqueous hydrolysis.

Against this backdrop, the invention aims to provide improved methods of recovering and recycling lithium salts from battery electrolyte solutions, especially recovering LiPF₆.

A further problem has been recognised in the recovery of LiPF₆ from spent batteries. LiPF₆ is a commonly used and commercially important electrolyte salt used in lithium batteries, but it is recognised as being a material which can be susceptible to hydrolysis. Normally, in typical non-aqueous battery electrolyte solutions LiPF₆ exists in an equilibrium as shown:

LiPF₆⇄LIF+PF₅

When small amounts of water are mixed with these solutions of LiPF₆, this equilibrium is pushed further to the right as PF₅ is hydrolysed, yielding additional products such as HF, fluorophosphates, phosphates and phosphoryl fluoride. POF₃. If enough water is present all of the LiPF₆ in these solutions will be consumed. The degradation products of LiPF₆ include compounds which are toxic, harmful, and can indeed lead to the further degradation of other solvents. Consequently, recycling of LiPF₆ has been seen as complicated and risky.

According to a first aspect, the invention provides a method of recovering a lithium salt from a lithium battery waste mass, comprising the steps of:
(a) dissolving the lithium salt in the lithium battery waste mass in a weight of water equivalent to 100-0.1 times the weight of the lithium battery waste mass, either in a one-off treatment or successive treatments;
(b) evaporating the aqueous solution to dryness; and
(c) working up the dry residue with a solvent comprising water, a carbonate, or mixtures thereof.

According to a second aspect, the invention provides a method of recovering a lithium salt from a lithium battery waste mass, comprising the steps of:
a) dissolving the lithium salt in the lithium battery waste mass in a weight of solvent equivalent to 100 to 0.1 times the weight of the lithium battery waste mass, either in a one-off treatment or successive treatments;
b) evaporating the solvent solution to dryness; and
c) working up the dry residue with a solvent comprising water, an organic solvent, or mixtures thereof.

Preferably, the final working up step serves to effect a purification of the recovered electrolyte salt.

In a preferred aspect, the carbonate solvent is dimethyl carbonate, diethyl carbonate, ethyl methyl carbonate, or mixtures thereof. In an embodiment, the carbonate solvent is ethyl methyl carbonate. In a preferred aspect, the work-up step is carried out using a carbonate solvent containing low levels of water such that the carbonate solvent and the water are still miscible at 25° C.

In terms of the recovery process, waste battery cells can be treated mechanically, which leaves a fine fraction comprising active electrode and electrolyte material, known as ‘black mass’. Conveniently, the lithium battery waste mass comprises black mass, and conveniently may consist essentially of black mass. Conveniently, the black mass may comprise at least 80 wt % of the lithium battery waste mass. Black mass is the name given to the powder substance resulting when end-of-life lithium batteries are discharged, disassembled, crushed, shredded, sorted and sieved. Black mass typically contains a number of materials, including cobalt, nickel, copper, lithium, manganese, aluminium and graphite. Further metallurgic treatments can follow, allowing for extraction of other components, which can include fluorine-containing salts and their degradation products.

Black mass is deemed one of the most valuable fractions in battery recycling, due to its concentration of electrode components such as graphite, nickel, manganese, cobalt, lithium, and electrolyte components including conducting salts.

In an embodiment, the lithium battery waste mass, conveniently the black mass, is dry. By “dry” in this context we mean that the black mass contains less than 20 g/kg of liquid such as the electrolyte solvent and/or water, conveniently less than 10 g/kg of liquid, conveniently less than 5 g/kg of liquid, conveniently less than 1 g/kg of liquid.

The present inventors have surprisingly found that water can be used to extract lithium hexafluorophosphate, LiPF₆ from dry black mass without hydrolysis of the salt or compromising the recovery of electrode components. Thereafter the solution is evaporated to dryness. The material left over can then be worked up in water or a carbonate solvent to effect further purification. Conveniently the carbonate solvent can be dimethyl carbonate, diethyl carbonate, ethyl methyl carbonate, or mixtures thereof; conveniently the carbonate solvent is ethyl methyl carbonate.

Without wishing to be bound by theory, and notwithstanding the dynamic equilibrium in respect of LiPF₆ discussed above, the inventors have surprisingly found that the degradation of LiPF₆ in water does not occur as readily as expected. In terms of the initial aqueous dissolution step in the presence of lithium battery waste mass, especially dry lithium battery waste mass and especially dry black mass, it is preferable that this is carried out in conditions so as to minimise LiPF₆ hydrolysis. Notwithstanding the known hydrolytic instability of LiPF₆, we have found that hydrolysis is minimised either when the LiPF₆ is either substantially dry, or when the LiPF₆ is present in large amounts of water, in which it is relatively stable.

When lithium battery waste mass, especially back mass, is rinsed with water, the lithium salts, especially LiPF₆, tend to be the most water-soluble salts present. Hence, extraction of black mass with water has the effect of concentrating and to a degree purifying the lithium salts present, especially the LiPF₆.

However, the inventors were surprised to find that as the aqueous solution of LiPF₆ salt was dried, the expected degradation of LiPF₆ did not occur. In the subsequent steps of the process, in which the dried lithium salts are worked up with a carbonate solvent or water, likewise the LiPF₆ proved to be surprisingly stable. The inventors' findings suggest that LiPF₆ is stable when it is fully solvated by water, but not so when it is partially solvated. In order to minimise any detrimental degradation of the LiPF₆, the detailed steps of the process are selected so as to minimise the time that the LiPF₆ is exposed to water in an amount which is not sufficient to fully solvate it. Given that the prior art teachings require in general multi-stage treatments in which in general LiPF₆ is not itself recovered but which lead to some other lithium salt, from which LiPF₆ needs to re-synthesised, the invention provides a surprisingly effective and simple process for the recovery and recycling of lithium salts from batteries, especially LiPF₆.

Surprisingly, given its relative hydrolytic instability, LiPF₆ remains present and stable through these processes. Ethyl methyl carbonate was shown to be far more selective to the dissolution of the PF₆ anion compared to water during workup.

In an embodiment, the initial dissolution step involves adding water to the lithium ion waste mass at a relatively low temperature; preferably this is less than 50° C., preferably less than 40° C., preferably less than 30° C., preferably less than 25° C. Preferably the water that is added is more than 95 wt % pure, more preferably more than 98 wt % pure, preferably more than 99 wt % pure; preferably the water contains no more than trace impurities.

In an embodiment, the contact time of the water with the lithium battery waste mass may be no more than 10 hours, preferably it may be no more than 5 hours, preferably it may be no more than 2 hours, and in some embodiments it may be no more than 1 hour or 30 minutes. In other embodiments, the contact time may be less than 10 minutes, conveniently less than 5 minutes, conveniently less than 2 minutes, conveniently less than 1 minute.

In the evaporation to dryness step, it is preferred that the temperature of the drying solution does not rise above the preferred temperatures outlined above for the dissolution step. To this end, vacuum filtration or spray drying is a preferred method of evaporating the aqueous solution to dryness; in certain embodiments, spray drying may be preferred.

In an embodiment, in step (a) the water is drawn through the lithium battery waste mass (e.g. black mass) under vacuum. In a further embodiment, in step (a) the water passes through the lithium battery waste mass dynamically (i.e., not in a batch process).

In an embodiment, the weight ratio of water to lithium battery waste mass (e.g. black mass) in the extraction step is in the ratio 100 to 0.1:1, conveniently 10 to 0.5:1, conveniently 7 to 0.5:1, conveniently 5 to 0.5:1, conveniently 3 to 0.5:1.

### EXAMPLES

### Example 1—Aqueous Extraction Procedure

Recycled battery mass powder (commonly referred to as black mass) was provided for use generated from the processing of used batteries with NMC622 cathode and graphite anode. It was estimated that at most this material would contain c.a. 2% wt of LiPF₆ and so this figure was used for reference when calculating yields etc. LiPF₆ is understood to be soluble in water and despite a high instability towards hydrolysis, it is stable when fully solvated by water, but unstable until it is fully solvated by water. An initial study looked to identify any variations between experimental parameters, including extraction/mixing time, and water volume used. The results are presented in Table 1.

The mass of black mass (5 g), mixing speed and room temperature were kept constant. Each experiment yielded LiPF₆ as confirmed by ¹⁹F and ³¹P NMR analysis of the extract solutions, and whilst the influence of extraction time did not appear significant in determining how much LiPF₆ and other species were extracted, the volume of water used did have an impact. In particular, reducing the amount of water used for the extraction led to improved LiPF₆ recovery.

TABLE 1

| H₂O | | | | Mmol PF₆ | |
|---|---|---|---|---|---|
| volume | Mix | | | before | |
| (mL) | time (h) | Mmol PF₆⁻ | Mmol F⁻ | hydrolysis | Recovery % |
| 10 | 1.5 | 0.380 | 0.327 | 0.434 | 87.5 |
| 10 | 1.5 | 0.376 | 0.331 | 0.431 | 87.2 |
| 10 | 4.5 | 0.327 | 0.241 | 0.367 | 89.0 |
| 10 | 4.5 | 0.414 | 0.325 | 0.469 | 88.4 |
| 20 | 3.0 | 0.360 | 0.534 | 0.449 | 80.2 |
| 20 | 3.0 | 0.432 | 0.715 | 0.551 | 78.4 |
| 20 | 3.0 | 0.430 | 0.711 | 0.548 | 78.4 |
| 30 | 1.5 | 0.440 | 0.916 | 0.593 | 74.2 |
| 30 | 1.5 | 0.453 | 0.889 | 0.601 | 75.4 |
| 30 | 4.5 | 0.376 | 0.935 | 0.614 | 74.6 |
| 30 | 4.5 | 0.458 | 0.783 | 0.507 | 74.2 |

Subsequently, a four-fold scale up of water volume and battery material mass was used to reduce the impact of sample heterogeneity of the black mass on yield. In this experiment 20 g of black mass was extracted with 80 ml of water for three hours and resulted in an LiPF₆ recovery of 78.5%, similar to the equivalent small-scale experiment.

In a further experiment, 20 mL of water was passed through a bed of 5 g black mass in a column held in place with a filter paper which resulted in an LiPF₆ recovery yield of 89.1% with significantly reduced levels of fluoride. It could be assumed that any PF₆ anion present in the black mass can undergo hydrolysis if given enough time and water, and so the key to recovering it in good yield is to optimise the amount of water relative to the black mass, the contacting time and the mode of contacting, for example batch or dynamic. However, it was found that the extraction step can be operated with these parameters across a wide range and still be effective.

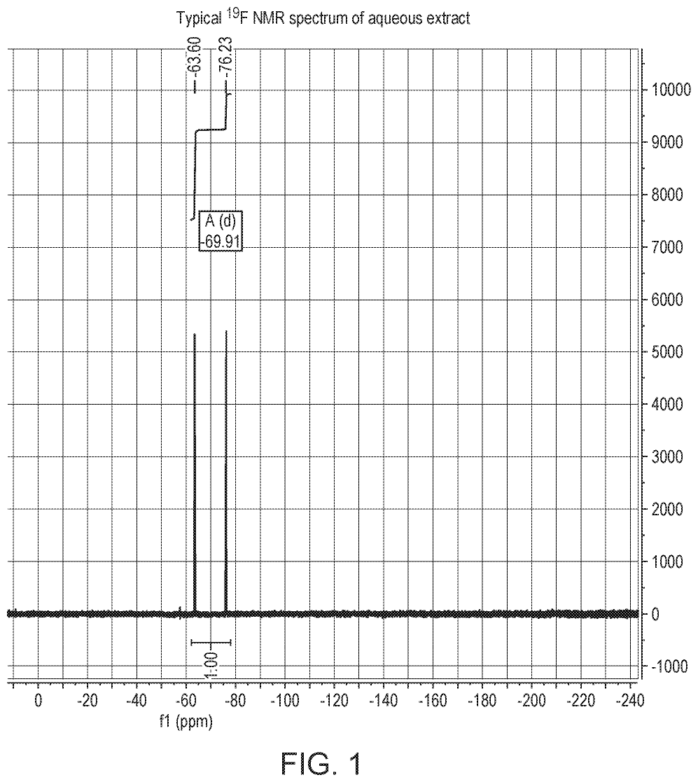

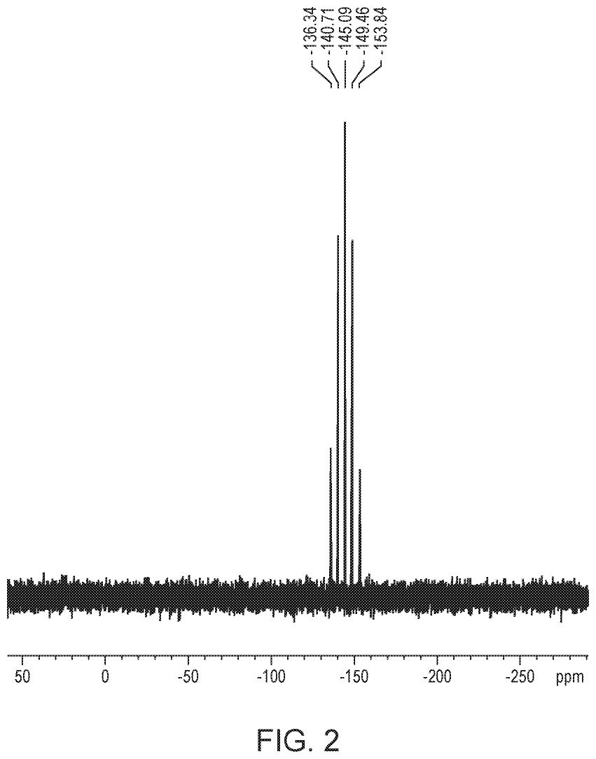

FIGS. 1 and 2 show typical ¹⁹F and ³¹P NMR spectra of the aqueous extracts which serve to confirm the presence of the PF₆ anion in the aqueous extract solutions.

### Example 2—Extraction and Recovery of LiPF₆ from Black Mass

### Aqueous Extraction of Black Mass Powder

The soluble components from a sample of black mass (5 g) material were extracted with water (10 mL) using batch contacting in an open beaker with mixing for a defined period (1.5 h). After this defined period the orange-tinted mixture obtained was filtered under vacuum, yielding an orange-tinted filtrate which was made up to 10 mL with water. This solution was analysed by ¹⁹F and ³¹P NMR to confirm the presence of the PF₆ anion and determine its concentration and hence recovery rate. A doublet was observed by ¹⁹F NMR and a heptet by ³¹P NMR and the amount of LiPF₆ in solution was determined by ¹⁹F NMR to be equivalent to 10.97 mg/g black mass.

Removal of Solvent from Filtrate

Some filtrate was transferred to a 75 mL round-bottomed flask and the water removed in vacuo at 30 mbar and 45° C. Under these conditions all of the solvent was removed in less than 30 minutes.

The solid residue obtained after water removal was redissolved in water (10 mL) and the solution so obtained was again analysed by ¹⁹F and ³¹P NMR which showed that the PF₆ anion survived the water removal and re-dissolving steps largely intact. By ¹⁹F NMR the LiPF₆ content of this solution was determined to be 10.80 mg/g black mass, slightly reduced from the 10.97 mg/g black mass in the original extract solution.

Selective Extraction of LiPF₆ from Solid Residue into Ethyl Methyl Carbonate (EMC)

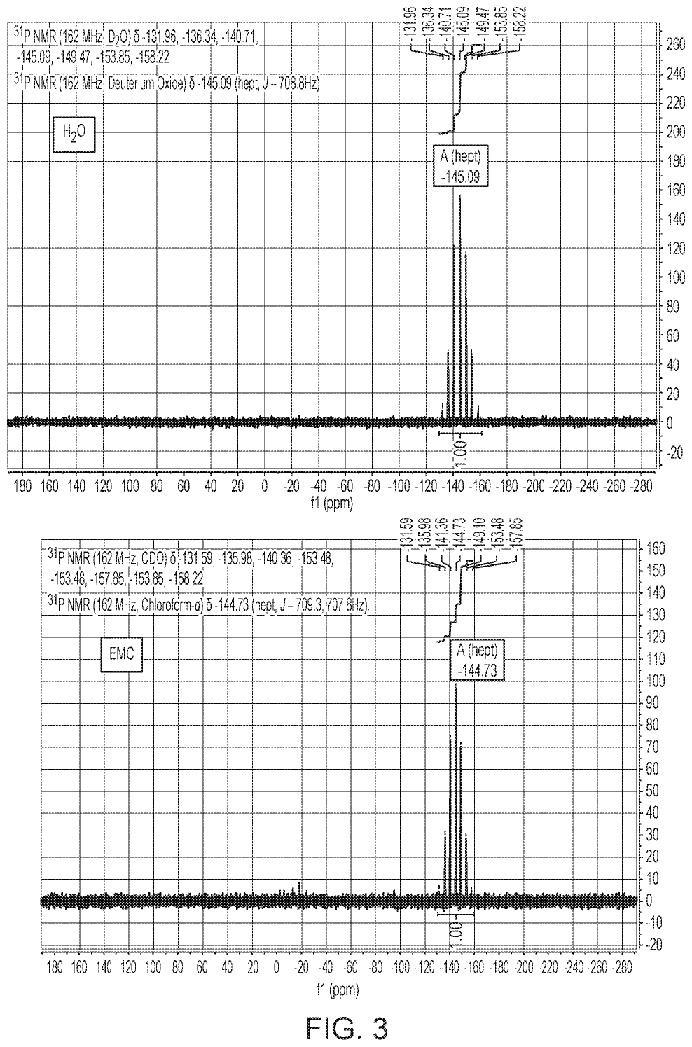

The extraction and evaporation steps described above were repeated and the solid residue obtained extracted with EMC. The aqueous extract and EMC solution so obtained was analysed by ³¹P NMR spectroscopy which showed that the PF₆ anion survived the extraction and evaporation processes intact and was extracted from the evaporation residue by EMC, see FIG. 3.

### Stability of PF₆ Anion in EMC Solvent

A sample of PF₆ anion recovered by extraction into EMC was stored over a period of 15 days. ¹⁹F NMR was used to quantify the concentration of the PF₆ anion in solution over this period. The results are shown below in Table 2, and show the PF₆ anion is stable in EMC after removal of water and extraction into EMC for at least two weeks.

TABLE 2

| Day | Mmol PF₆ |
|---|---|
| 1 | 0.175 |
| 8 | 0.161 |
| 11 | 0.165 |
| 15 | 0.158 |

### Example 3: Repeated Demonstration of Process Steps

The basic aqueous extraction, solvent removal and extraction of solids with EMC procedure of Example 2 was repeated six times, and the results are summarised in Table 3. The amount of LiPF₆ extracted and recovered in the EMC solution was quantified by ¹⁹F NMR with confirmation by ³¹P NMR.

TABLE 3

| Experiment | 1 | 2 | 3 | 4 | 5 | 6 |
|---|---|---|---|---|---|---|
| LiPF₆ yield | 0.99 | 1.10 | 1.14 | 0.74 | 0.75 | 0.74 |
| (% wt Black | | | | | | |
| mass) | | | | | | |

### Example 4: Repeated Washing/Process Steps

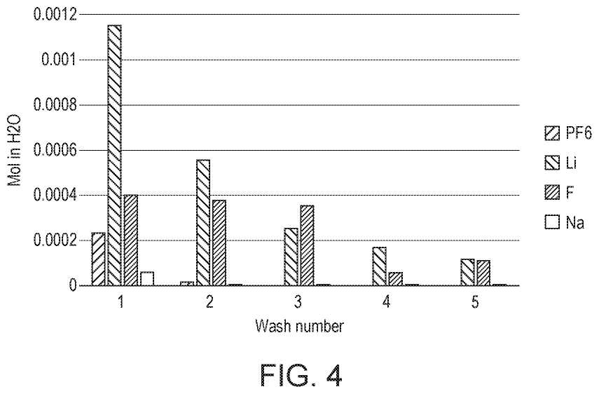

The basic aqueous extraction, solvent removal and extraction of solids of Example 2 was repeated on the same sample five times, and the results are summarised in FIG. 4. The amount of LiPF₆ extracted and recovered was quantified by ¹⁹F NMR with confirmation by ³¹P NMR.

### Example 5: Extraction and Recovery of LiPF₆ from Black Mass

The basic aqueous extraction, solvent removal and extraction of solids of Example 2 was repeated on three different battery material samples (200 g) with 100 mL solvent, and the results are summarised in Table 4. The amount of LiPF₆ extracted and recovered was quantified by ¹⁹F NMR with confirmation by ³¹P NMR.

TABLE 4

| | | LiPF₆ |
|---|---|---|
| | | extracted |
| Sample of Black Maa | Solvent | (wt %) |
| Heavily dried, end of life batteries | Water | 0.22 |
| Minimal drying, partially used batteries | Water | 1.09 |
| Electrolyte-doped jelly rolls (1M LiPF₆) | Water | 3.32 |
| Electrolyte-doped jelly rolls (1M LiPF₆) | Organic (DMC) | 1.99 |

### Example 6: Extraction and Recovery of LiPF₆ from Black Mass

Solvent Extraction with Water or EMC

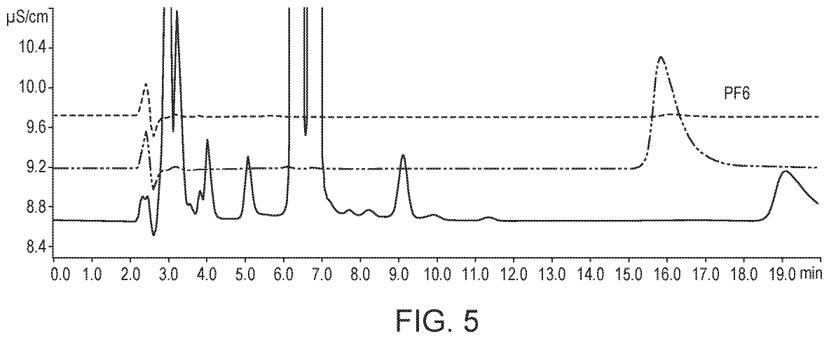

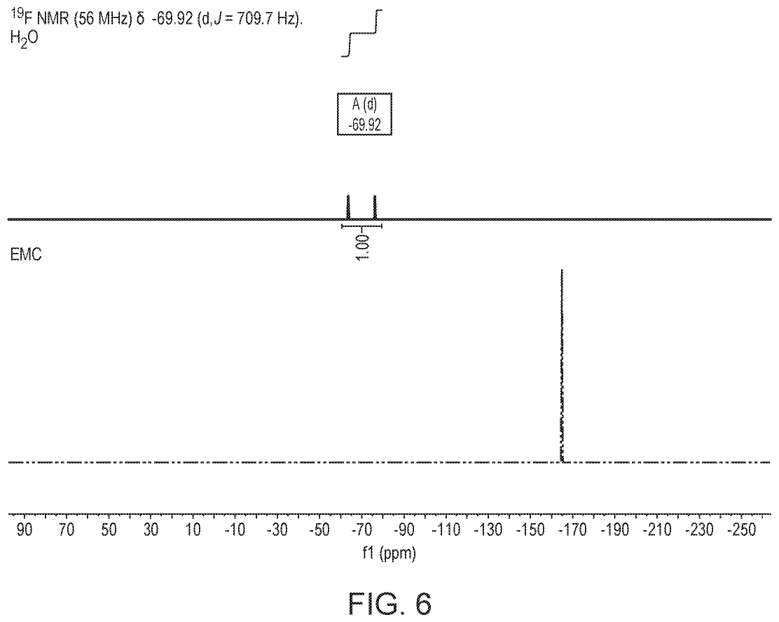

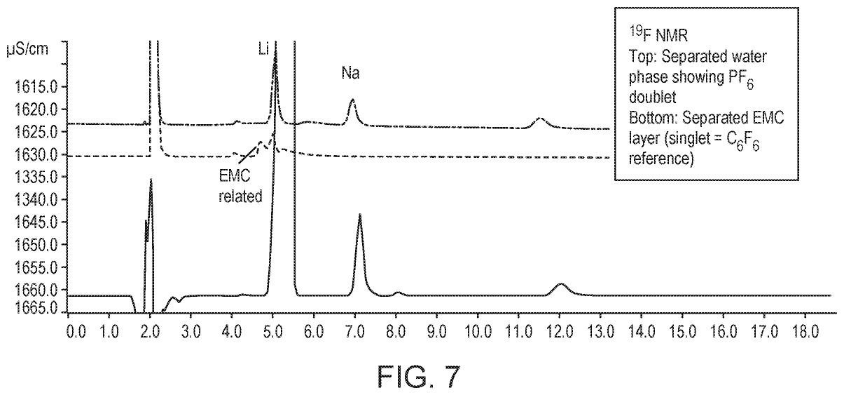

The basic aqueous extraction, solvent removal and extraction of solids of Example 2 was repeated on three different battery material samples (200 g) with 100 mL solvent, and the results are summarised in FIGS. 5 to 7. Both layers analysed by ion chromatography (top—anions, bottom—cations). The blue profile is the separated aqueous composition, and the pink profile that of the remaining EMC mixture. The amount of LiPF₆ extracted and recovered was quantified by ¹⁹F NMR with confirmation by ³¹P NMR.

The black profile is the direct extract from the battery material with water. It can clearly be seen that the majority of PF₆—, along with Li+ and some Na+ have transferred into the aqueous phase leaving some residual ions in the EMC.

### Further Extraction of EMC Extract

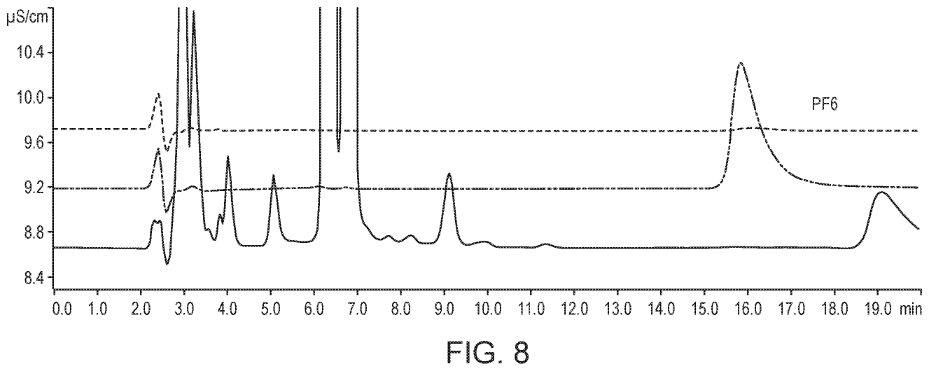

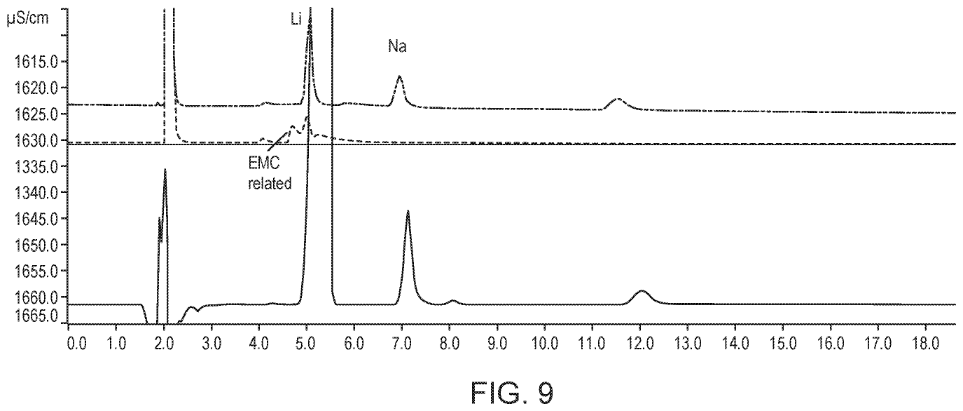

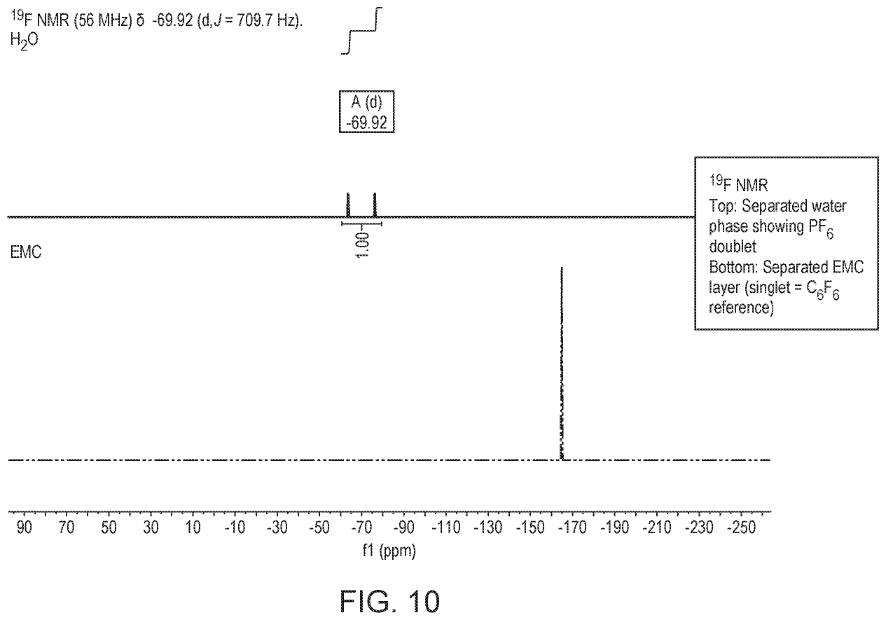

The EMC mixture containing LiPF₆ was washed with the same volume of water, and ether added to encourage separation of organic and aqueous layer. Both layers analysed by ion chromatography (top—anions, bottom—cations) and the results are summarised in FIGS. 8 to 10. The blue profile is the separated aqueous composition, and the pink profile that of the remaining EMC mixture. The black profile is the direct extract from the battery material with water. It can clearly be seen that the majority of PF₆⁻, along with Li⁺ and some Na⁺ have transferred into the aqueous phase leaving some residual ions in the EMC.

### Example 7: Extraction and Recovery of LiPF₆ from Black Mass

Solvent Extraction with Water or EMC

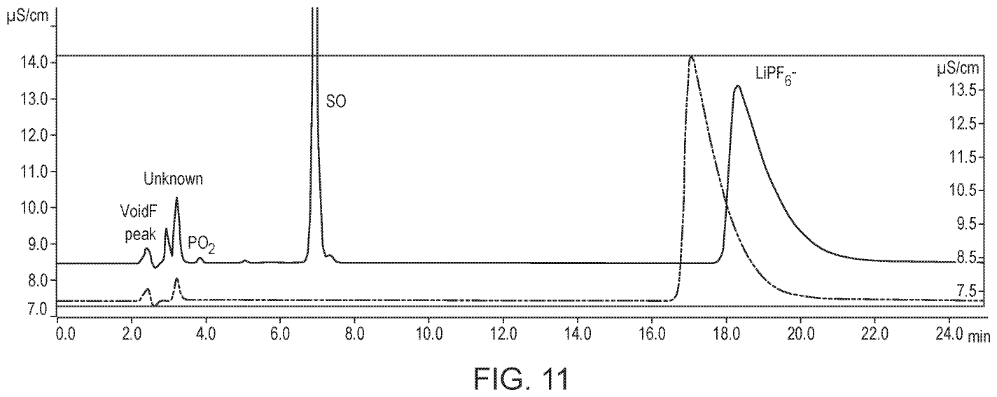

The basic aqueous extraction, solvent removal and extraction of solids of Example 2 was repeated on different battery material samples (200 g) with 100 mL solvent (DMC or water), and the results are summarised in FIG. 11 (DMC (blue); water (black)). The amount of LiPF₆ extracted and recovered was quantified by ¹⁹F NMR with confirmation by ³¹P NMR.

It can be seen that extracting LiPF₆ with an organic carbonate does not extract all the other components that is observed when water is used. The bulk of the DMC extracted material is LiPF₆.

### Example 8: Extraction and Recovery of LiPF₆ from Black Mass

Solvent Extraction with Water

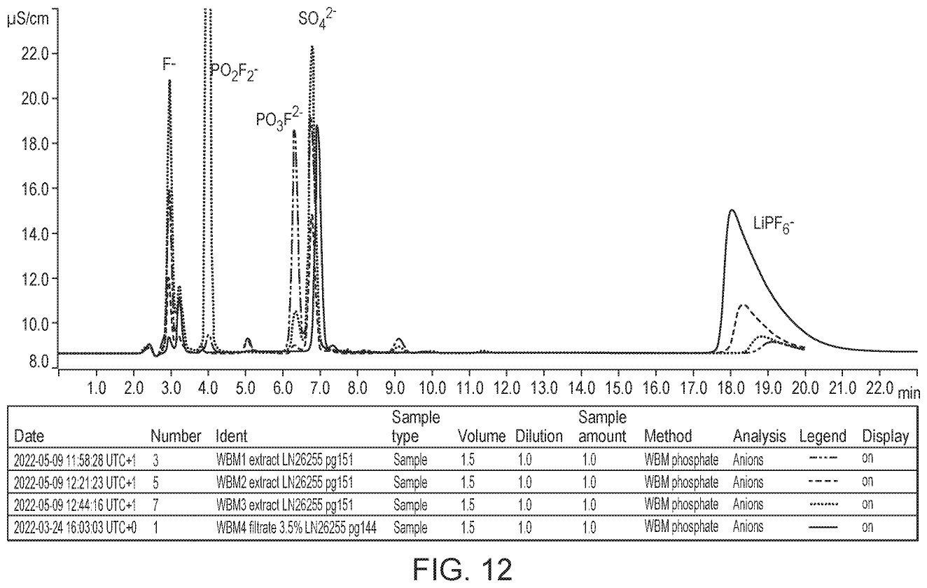

The basic aqueous extraction, solvent removal and extraction of solids of Example 2 was repeated on four different battery material samples (200 g) with 100 mL solvent (water), and the results are summarised in FIG. 12 (DMC (blue); water (black)). The amount of LiPF₆ extracted and recovered was quantified by ¹⁹F NMR with confirmation by ³¹P NMR.

It can be seen that different samples exhibit different amounts of LiPF₆ and degree of hydrolysis of existing LiPF₆. Figure shows anion chromatograms.

### Example 9: Measurement and Extraction and Recovery of LiPF₆ with Different Solvents

### Solvent Extraction

Aqueous extraction, solvent removal and extraction of solids was performed.

The measurement of LiPF₆ extracted using different solvents; based on the concentrations of either PF₆ anion or the Li cation (with ion chromatography) in various solvents is shown in Table 5 below.

TABLE 5

| | | | Wt. % LiPF₆ in WBM | | |
|---|---|---|---|---|---|
| | Battery | | Based on | Based on | Difference |
| Batch | Type | Solvent | [PF₆] | [Li] | (%) |
| WBM1 | Unknown | Water | 0.10 | 2.45 | 2350 |
| | | EMC | 0.064 | 0.066 | 3.13 |
| WBM2 | EV field returns | Water | 0.58 | 1.75 | 201.7 |
| | | EMC | 0.83 | 0.79 | 4.82 |
| WBM3 | Mfg scrap | Water | 0.19 | 1.94 | 921.1 |
| | | EMC | / | / | / |
| WBM4 | Doped jelly rolls | Water | 2.14 | 4.81 | 124.8 |
| | | EMC | 1.22 | 1.35 | 10.7 |
| WBM5 | EV field returns (different supplier) | Water | / | / | / |
| | | EMC | 0.00 | 0.15 | / |

Assuming the concentration of LiPF₆ is based on both the amount of PF₆ and the amount of Li, there is shown a massive excess of Li when water is used as the extractant compared to EMC.

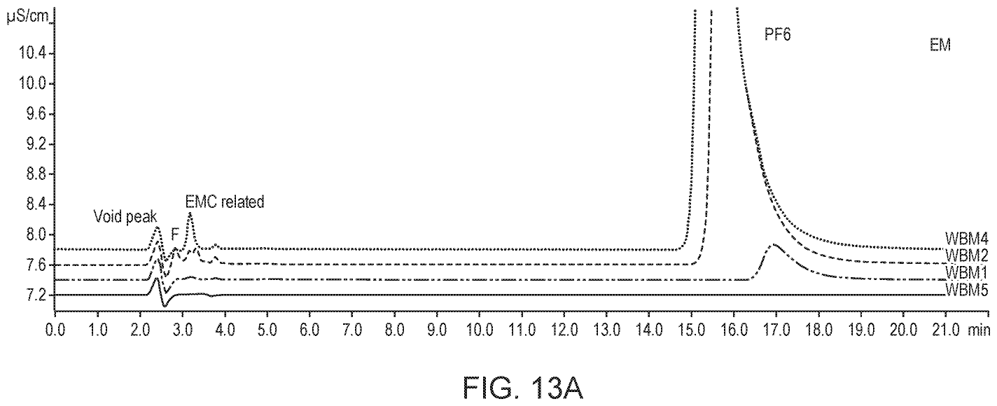

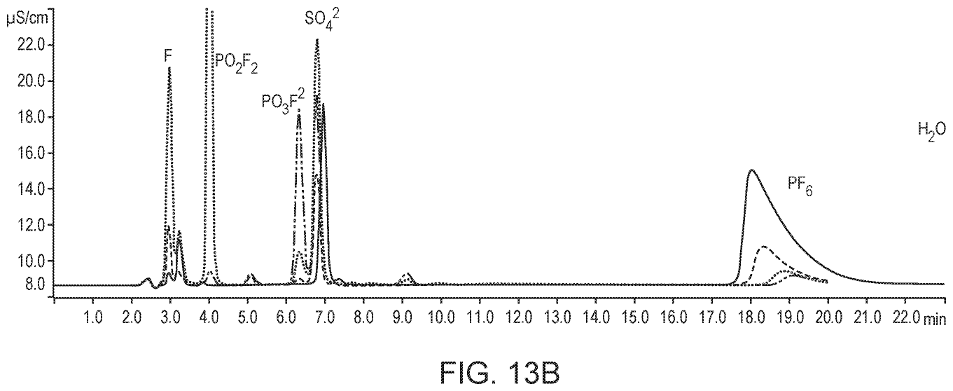

These results are shown pictorially in FIGS. 13a and 13b.

It can be seen that there is a clear difference in additional components extracted from black mass samples when using water vs EMC. Shown above are anion chromatograms (colours not the same WBM batch).

### Example 10

200 g of waste battery material was washed with 100 mL EMC. The filtrate was split in three aliquots; one untreated, 7 g 4 Å molecular sieve added to one, 7 g MgO pellets to another. Both left in fume cupboard for one week and analysed by coulometric Karl-Fisher for moisture, and IC for decomposition. The results are shown in Table 6 below.

TABLE 6

| | | | Water |
|---|---|---|---|
| | Drying | Drying agent | concentration |
| Sample ID | agent | pre-treatment | (ppm) |
| Dry EMC | / | / | 94 |
| Untreated | / | / | 2433 |
| Extract | | | |
| EMC-Z4 Å | Zeolite 4 Å | 306° C., 36 h | 8 |
| | pellets | | |
| EMC-MgO | MgO | 306° C., 36 h | 2690 |
| | pellets | | |

This shows the importance of drying solvent immediately as it picks up a lot of moisture during LiPF₆ extraction and hydrolyses into the known decomposition products.

1. A method of recovering a lithium salt from a lithium battery waste mass, comprising the steps of:
(a) dissolving the lithium salt in the lithium battery waste mass in a weight of water equivalent to 100 to 0.1 times the weight of the lithium battery waste mass, either in a one-off treatment or successive treatments;
(b) evaporating the aqueous solution to dryness; and
(c) working up the dry residue with a solvent comprising water, an organic solvent, or mixtures thereof.

2. A method of recovering a lithium salt from a lithium battery waste mass, comprising the steps of:
a) dissolving the lithium salt in the lithium battery waste mass in a weight of solvent equivalent to 100 to 0.1 times the weight of the lithium battery waste mass, either in a one-off treatment or successive treatments;
b) evaporating the solvent solution to dryness; and
c) working up the dry residue with a solvent comprising water, an organic solvent, or mixtures thereof.

3. The method according to claim 2, wherein the solvent in step (a) comprises an ether solvent, a nitrile solvent, a carboxylate solvent, or a carbonate solvent containing no water, or containing low levels of water such that the water and the solvent are still miscible at 25° C.

4. The method according to claim 1, wherein the solvent in step (c) comprises an ether solvent, a nitrile solvent, a carboxylate solvent, or a carbonate solvent containing no water, or containing low levels of water such that the water and the solvent are still miscible at 25° C.

5. The method according to claim 4, in which the final working up step (c) serves to effect a purification of the recovered electrolyte salt.

6. The method according to claim 5, in which the carbonate solvent is dimethyl carbonate, diethyl carbonate, ethyl methyl carbonate, propylene carbonate, or mixtures thereof.

7. The method according to claim 5, in which solvent used in the working up step (c) comprises is a carbonate solvent containing no water, or containing low levels of water such that the water and carbonate solvent are still miscible at 25° C.

8. The method according to claim 1, in which lithium battery waste mass comprises black mass.

9. The method according to claim 8 in which the black mass comprises at least 80 wt % of the lithium battery waste mass.

10. The method according to claim 1, in which the lithium battery waste mass prior to step (a) is dry, or containing less than 20 g/kg of liquid.

11. The method according to claim 1, in which the lithium salt is LiPF₆.

12. The method according to claim 1, in which dissolution step (a) is carried out at a temperature of less than 50° C.

13. The method according to claim 1, in which dissolution step (a) is carried out using water which is more than 95 wt % pure.

14. The method according to claim 1, in which the contact time of the water with the lithium ion battery mass in step (a) is less than 5 hours, or less than 10 minutes.

15. The method according to claim 1, in which the evaporating to dryness step (b) is carried out by vacuum evaporation or spray drying.

16. The method according to claim 1, in which dissolution step (a) is carried out dynamically.

17. The method according to claim 1, in which the weight ratio of water to lithium battery waste mass is 10 to 0.5:1, or 3 to 0.5:1.

18. The method according to claim 4, wherein the solvent in step (c) is independently selected from the group consisting of diethyl ether, acetonitrile, propionitrile, ethyl acetate, propylene carbonate, dimethyl carbonate, diethyl carbonate, ethyl methyl carbonate, and any mixture thereof.

19. The method according to claim 3, wherein the solvent in step (c) comprises an ether solvent, a nitrile solvent, a carboxylate solvent, or a carbonate solvent containing no water, or containing low levels of water such that the water and the solvent are still miscible at 25° C.

20. The method according to claim 19, wherein the solvent in either or both of step (a) or step (c) is independently selected from the group consisting of diethyl ether, acetonitrile, propionitrile, ethyl acetate, propylene carbonate, dimethyl carbonate, diethyl carbonate, ethyl methyl carbonate, and any mixture thereof.
